(19) United States
(12) Patent Application Publication
(10) Pub. No.: US 2008/0235090 A1
(43) Pub. Date: Sep. 25, 2008

(54) METHOD AND ARRANGEMENT FOR MANAGING PERSONALIZED ADVERTISEMENTS IN A TV SYSTEM

(76) Inventors: Olof Lundstrom, Stockholm (SE); Ayodele Damola, Kista (SE)

Correspondence Address: ERICSSON INC., 6300 LEGACY DRIVE, M/S EVR 1-C-11, PLANO, TX, 75024, US

(21) Appl. No.: 11/856,440

(22) Filed: Sep. 17, 2007

Related U.S. Application Data
(60) Provisional application No. 60/896,657, filed on Mar. 23, 2007.

(51) Int. Cl. G06Q 30/00

(52) U.S. Cl. 705/14

(57) ABSTRACT

The invention discloses a method and arrangement of managing personalized advertisement in an TV system including an TV client (103), a User Preference Database (109), an Ad Providers Database (108) and an Advertising Application Server (105). The Advertising Application Server (105) detects that a user (John.Brown@op.net) is present at the TV client. Then the Advertising Application Server (105) receives, from said User Preference Database, preferences of said detected user. Also the Advertising Application Server (105) receives, from the Ad Providers Database, information on advertisements from different Ad providers. The received information is used by the Advertising Application Server (105) to match said received user preferences with received advertisements from the matching it is selected one or more advertisements. If there are Advertisements from more than one Ad Provider selected then there is a connection with a Transaction Broker for performing an auction among the Ad Providers. The Ad Provider with the highest bid will get its advertisement sent to the user.

### CROSS-REFERENCE TO RELATED APPLICATIONS

This application which claims the benefit of U.S. Provisional Application No. 60/896,657, filed Mar. 23, 2007, the disclosure of which is incorporated herein by reference.

### TECHNICAL FIELD

The present invention generally relates to management of advertisements in communications systems, and in particular to personalized advertisement and methods for selecting which advertisement to show to a user in a TV system.

### BACKGROUND

The IV advertisement market and the internet advertisement market are together an important part of the total advertisement market. Internet and TV advertisement trends point towards stepwise convergence but today there are still big differences.

TV advertisements are typically presented to the TV audience during breaks between TV programs and in the middle of a TV program. The advertisements are usually in the form of a short film which contains both video and audio. The content and marketing message of a specific advertisement is intended to attract a certain target group which is most likely to purchase an advertised product. The advertisement target group should preferably match the TV audience. General knowledge, such as gender, age etc about the audience is based on the content of the TV program adjacent to the advertisement break. For example an advertisement for a family car could be presented in the break adjacent to a family program. The problem is that TV advertisers can only make guesses and estimates of the viewers watching the advertisement.

Internet advertisements are typically presented either as banners on a web page or based on key words from a web search. They contain everything from pure text to audio, picture and video. The content and message of a specific advertisement is also in the Internet advertising case intended to attract a certain target group. The knowledge about the Internet user and how well the interests of the user match the advertisement can be derived from the context in which the advertisement is presented. For example a car website would probably attract individuals with an interest in cars. A car advertisement presented in the context of the car website could potentially attract some attention from the users. In the same way could a car advertisement that is presented when a user searches for “cars” obtain some interest. As a result, the advertisement target group would on some level be the same as the user of the Internet website.

Thus, the described prior art has limitations in accuracy of the match between the advertisement marketing message and the actual preferences of the actual target group. This causes that the advertisement is in many cases not relevant to all persons to whom it is presented and it is therefore a waste of marketing money for the advertiser. Also consumers feel that they are constantly bombarded with too many marketing messages which causes a growing resistance and negativity towards advertisements.

With Internet advertising it is possible to achieve a more accurate match between advertisement target group and the actual user who views the advertisement. A known method of doing this is that the user fills in a form with information about herself and her profile. This procedure requires a special user account with separate user login and password.

According to U.S. Pat. No. 5,974,398 Hansson et al it is displayed on the user terminal screen the advertisers most willing to pay for the user attention and the dollar amount bid. If the user chooses to see a particular advertiser message the user is being reimbursed, or a credit is applied to the user service account for the amount of the bid promised by the advertiser whose message was viewed. Thus the user gets a payment to view an advertisement.

### SUMMARY

The present invention overcomes the drawbacks of the prior art arrangements and it is a general object of the present invention to provide a method and a system for delivering personalized advertisements to an TV client in a TV audience. It is also a general object to provide an Advertising Application Server in such an TV system

It is a particular object of the invention to provide a method and arrangement and system based on IMS that enables Advertisement Providers via an auction based business relationship with Service Providers to deliver personalized advertisements.

These and other objects are met by the invention as defined by the accompanying patent claims.

In a first aspect of the invention it is disclosed a method of managing personalized advertisement in an TV system including a TV client, a User Preference Database, an Ad Providers Database and an Advertising Application Server. The Advertising Application Server detects that a user is present at the TV client and upon the detection receives preferences of said detected user. Also received in the Advertising Application Server is information on advertisements in the Ad Providers Database. A matching is done in the Advertising Application Server by use of the preferences and the available advertisements. From the matching one or more advertisements possible to show for the user are selected.

The selection of advertisements can be done according to best match criteria only or best match criteria in combination with a most popular Ad criteria.

In a second aspect of the invention said method further comprises steps related to an auction method. In the Advertising Application Server it is determined that advertisements from more than one Ad Provider has been selected. Upon this determination an auction invitation is sent to a Transaction Broker where an auction is performed. The Advertising Application Server receives information about the Ad Provider with highest bid and can then initiate transmission of advertisement from highest bidder.

In a third aspect of the invention it is disclosed an Advertising Application Server in the IV system for managing personalized advertisement to be delivered to the TV client. Said Advertising Application Server comprises several functional units. There is a Detecting Unit for detection of user presence at the TV client. There is a Preference Storage for storing of user preferences and an Advertisement Storage for storing advertisements from different Ad providers. For matching of user preferences with advertisements there is a Matching Processor connected with a Selecting Unit for determining if Advertisements from one Ad Providers has been selected and a Transmitting Unit for initiating the delivery of the one or more advertisements to the TV client.

In a fourth aspect of the invention there is a TV system for delivering of personalized advertisements to an TV client. The system includes a Presence Server for determining user presence at the TV client, a User Preference Database for storing of user preferences and an Advertisement Application Server for matching of the user preferences with available advertisements upon user presence detected. The Advertisement Application Server initiates the delivery of matched advertisements to the TV client.

In a fifth aspect of the invention the TV system further includes a Transaction Broker connected with the Advertising Application Server for performing an auction and for transmitting information on the Ad provider with highest bid back to the Advertising Application Server.

In a sixth aspect of the invention it is disclosed a method in an TV system for delivering of personalized advertisements to an TV client where user preferences are stored in a User Preference Database and available advertisements area stored in an Ad Providers Database. The method includes monitoring of user presence at the TV client and upon detection of user presence there is a matching done with user preferences and available advertisements used as input and after the matching procedure there is a step of selecting one or more Advertisement to be delivered to the TV client.

The method in the TV system also includes showing selected advertisement or advertisements to the TV client when only one Ad Provider is having advertisements that have been selected in the selecting step.

The method further involves performing of an auction if advertisements from more than one Ad Provider has been selected and determining the highest bidder. Advertisement/s from highest bidder is/are being showed to the TV client.

A first advantage of the invention is that a user of a TV client receive only relevant advertisements since they are personalized and since the TV system is aware of user presence which is utilized in the invention. A second advantage of the invention is the introduction of an auction method when there are several Ad Providers that have matching advertisement selected for a user. A further advantage of the invention is that the technical system disclosed supports business relations between the Ad Providers and the Service Provider managing the personalized advertisement. For example a first payment by the Ad Provider is done when the Ad Provider is putting Advertisement information in the Ad Providers Database owned by and managed by the Service Provider. A second payment from the Ad Provider to the Service Provider is done by the Ad Provider when a selected Advertisement/s is showed to the viewer.

### SHORT DESCRIPTION OF THE DRAWINGS

The invention is understood by making reference to the following description taken together with the accompanying drawings, in which:

FIG. 1 is a schematic overview of a TV system of a communication system, to which the teachings of the present invention can be applied;

FIGS. 2a, 2b, 2c and 2d are flow diagrams illustrating operational steps carried out in the IPTV system according to the present invention:

FIG. 3 is an example of a user preference database:

FIG. 4 is an example of an Advertising Provider Database with information related to several Ad providers;

FIG. 5 is a sequence diagram illustrating signals in the communications system according to an embodiment of the present invention;

FIG. 6 is a block diagram of an Advertising Application Server according to one example.

### DETAILED DESCRIPTION

Throughout the drawings, the same reference characters will be used for corresponding or similar elements. Ad is used throughout the description for Advertisement or in the case Ad. AS, Ad is used for Advertising.

The present invention relates to management of advertisements in a communication system in particular personalized advertisements delivered to the user. One benefit is an increased satisfaction of the viewer who can watch advertisements in areas of interest while the advertiser has spent advertising cost only on possibly interested receivers.

The teachings of the present invention can be applied to any TV system that authenticates the user when the user is starting to watch TV on a terminal or client connected in the system. According to the example presented there is an Internet Protocol Television, IPTV, system including an IP Multimedia, IMS, system for management of control signals. IPTV (Internet Protocol TV) is a term used when delivering broadcasted TV-services over an IP network, typically a broadcast access network. In the example described the signaling is SIP Session Initiation Protocol signaling which is applicable for IMS systems but other signaling systems may be used as well.

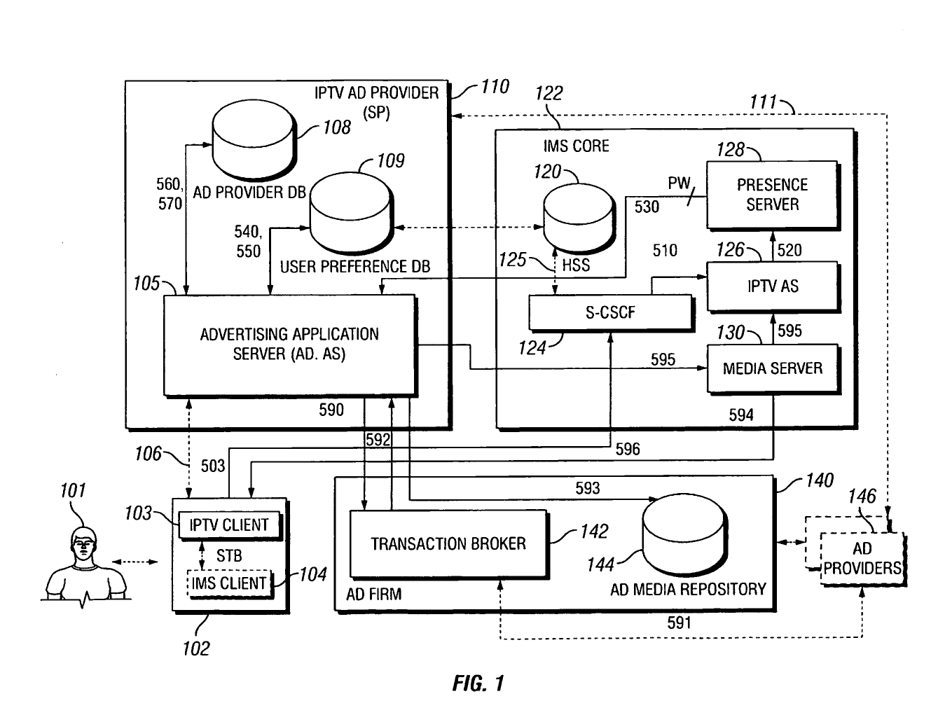

FIG. 1 discloses a block diagram of an IPTV system for implementing the invention. A User 101, John Brown, having a Set Top Box STB 102 with an IPTV client 103 initially makes a subscription for an IPTV service with a Service Provider SP 110. The IPTV client 103 is being registered with an Advertising Application Server Ad AS 105, which in this example is owned by the Service Provider SP which in FIG. 1 is named IPTV Ad Provider 110. The registration 106 is indicated with dotted lines. The Ad. AS 105 is connected with an Ad Providers Database 108, for getting information about Ad Providers and their available advertisements. The Ad. AS is also connected to a User Preference Database DB 109, for receiving information on user profiles related to advertisement. According to the invention user profile information is being used to determine the most appropriate advertisement to send and show to the user. The User Preference Database 109 is loaded with subscription information from the Home Subscriber Server HSS 120, which loading is indicated with a dotted line 107. Thus, there is an association in the Preference Database 109 with the user identity in the IMS system. The HSS is the main database keeping subscriber data and authentication data. The Ad. AS 105 together with the Ad Providers DB 108 and the User Preference DB 109 together forms a Service Provider SP which in this example is named IPTV Ad provider 110.

The personalized advertisement service according to this invention is based on the IMS presence service. As defined in the IMS standard there are 3 main actors in the IMS presence scenario. The first actor is the IPTV client 103 which has the role of a presence user agent PUA. This entity publishes its presence status to the second actor which is a presence application server which in FIG. 1 is a Presence Server 128. For instance the presence status may be that the user John Smith is currently: online, offline, busy etc. The IMS Presence server 128 thus receives and stores current presence status from different PUA. A third actor in the IMS presence scenario is the watcher which is an entity which subscribes for the presence status of the PUA. In the described embodiment in FIG. 1 the watcher role is played by the earlier mentioned Advertising Application Server Ad. AS 105. The presence service interaction among the 3 main actors are like this: The Ad. AS 105 has a list of user IMS identities which correspond to IPTV subscriptions of users interested in personalized Ads. The Ad. AS 105 subscribes to the presence status of these users. When the IPTV client (of user John Smith for instance) registers to the IMS core, information about the presence status is transferred to the presence server 128 automatically. The Ad server 105 is being notified over the Pw interface about the update of presence status of the user, eg user John Smith is now online.

The HSS 120 is within the IMS Core system 122 which also includes a Serving-Call and Session Control Function S-CSCF 124 which node is the main control point for services and also authenticates the user. The S-CSCF is located in the home network of the user and accesses data in the HSS for performing the authentication and service approval. The HSS contains subscription information for every user and the subscription specifies a list of IMS services which a particular user can access. This authentication and service approval is not described in detail but is indicated with dotted lines 125 in FIG. 1. Upon a service request from the user the S-CSCF 124, after the authentication and service approval interacts with an IPTV AS 126 to initiate the TV service. Once the user is registered with the IPTV AS (Application Server) 126 and hence comes online the Ad AS is notified by the Presence Server 128. This is done in accordance with specification 3GPP TS23.141 and not further described. The IPTV AS 126 in turn is connected with the Presence Server 128 which stores information that the user has logged in and is using the IPTV service which means that the user is present and watches TV. The Presence Server 128 within the IMS Core system is connected with the Ad. AS 105 for transmitting information about user registrations in accordance with the description above. It is of importance for the invention that the user has authorized the IPTV Ad Provider 110 to get presence information from the Presence Server 128. In the IMS core 122 is also a Media Server 130 for sending TV programs with advertisements to the IPTV client 103 and the STB 102. TV programs or TV content is sent to the viewer on a broadband connection carrying Real-time Transport Protocol RTP traffic for instance. RTP is specified in RFC 3550. The control plane protocol could be either RTSP for unicast of IGMP for multicast. The Media Server 130 is controlled by and connected with the Ad. AS 105 via an interface implementing the H.248 protocol.

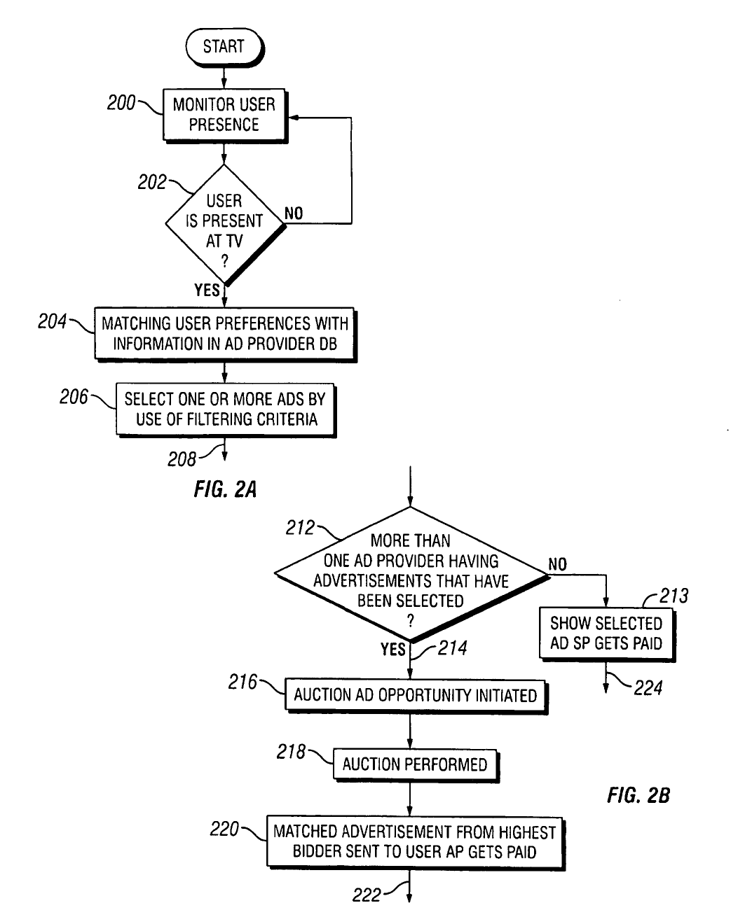

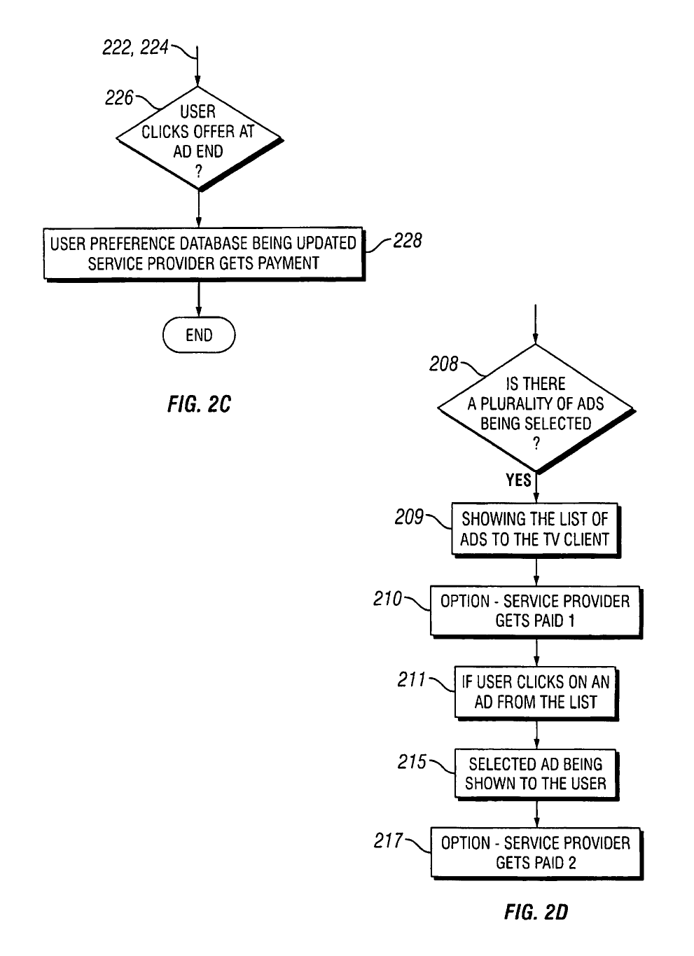

In FIG. 1 an example of an Ad Firm 140 consists of a Transaction Broker 142 and an Ad Media Repository 144. The Transaction Broker 142 is connected with the Ad. AS 105 for communication related to auctions if more than one Advertising Provider is possible for delivering of advertisement to the user. The Ad. Media Repository 144 is connected with the Ad. AS 105 for getting information on what Advertisement to transmit to the Media Server 130 for further delivery to the IPTV client 103. Ad Providers 146 are delivering different Advertisements, such as short films, to the Ad Firm 140 which Advertisements are stored in the Ad Media Repository 144. There is a connection between the Transaction Broker 142 and the Ad. AS 105 (illustrated with lines 590,592). Also there is a connection 591 between the Transaction Broker 142 and the Ad. Providers. These connections can be used for payment interaction from the Ad. Providers to the IPTV Provider according to descriptions in FIG. 2 below.

The mentioned connections 590 and 592 can be used to indicate an interface between the Service Provider 110 and the Ad Providers 146 for setting up an SLA (Service Level Agreement) which clarifies the responsibilities of each party for enabling delivery of personal advertisements and payment methods.

There is disclosed a connection by a dotted line 111 from the Ad Providers in order to exemplify the way of entering data into the Ad Providers Database. However, if is possible to enter data into the Ad Providers Database from the Ad Media Repository 144.

In FIG. 2 the main steps for carrying out the invention are illustrated. In FIG. 2a the initial step 200 is that the Ad. AS 105 is monitoring the user presence at the TV/STB. As soon as it is detected, in step 202, that the user is present at the TV, or online, a matching step 204 is performed. In the matching step 204 user preferences for advertisements are compared with advertisements from different Ad Providers in order to match these and find the most appropriate advertisement to send to the viewer. In step 206 one or more Advertisements Ads are selected. The amount of potential advertisements that could be relevant to a viewer could be immense. In order to select one or a few advertisements to be presented to the viewer this invention defines some filtering criteria to determine what advertisement to display to the viewer.

The main filtering criteria to be used is the best match criteria. This filter displays the Ad based on how well it matches the preference of the viewer. Another filtering criteria to be used in combination with the best match criteria, is the most popular ad criteria. This filter displays the ad based on how many times it has been viewed by other viewers. A popular ad is assumed to be of higher interest to the viewer than a less popular one. The advertised product is likely to have high quality, low price, being trendy or in some way attractive to many viewers. The general customer perception of the specific product is high. If the best match criteria result in several Ads possible to deliver to the user also the most popular ad criteria may be applied in order to reduce the number of ads to be displayed. If one Ad is selected after applying one or both filtering criteria this Ad is being displayed to the user in accordance with steps 212 and 213 disclosed in FIG. 2b. It may also be several Ads if they are from the same Ad Provider. Since the IPTV Ad Provider or Service Provider 110 has a business relation with the Ad Providers 146 the Service Provider can be paid by the Ad Provider when the selected Advertisements are shown to the user, see step 213 in FIG. 2b. There are several payment methods. According to one example several Ads has been selected. In such a situation a list of advertisements can be shown to the user and an alternative implementation of payment to the Service Provider can be made if the user/viewer chooses an Ad from the list of Ads.

If more than one Ad from one Ad Provider has been selected it is possible to show a list of advertisements to the IPTV client, which is shown in step 209 in FIG. 2d. When this list is shown to the user the Service Provider gets a first payment which is disclosed in step 210. If the user chooses any advertisement in the list, step 211, then the selected advertisement is being shown to the user, step 215. This initiates that the Service Provider gets a second payment, step 217.

In some situations, even after both mentioned filtering criteria has been applied in the matching step 204, Ads from more than one Ad Provider is being selected by the Ad. AS 105 to be displayed to the user or TV viewer. This situation is described in FIG. 2b step 212 and 214. In such a situation when more than one Ad provider has matching advertisements the Ad. AS 105 initiates an auction Ad opportunity in step 216. The auction is performed in step 218 by involvement of the Transaction Broker 142 (FIG. 1). The highest bidder is determined in the auction. In step 220 the advertisement from the highest bidder is sent to the user/TV viewer and optionally the Service Provider gets payment. The same procedure as in step 213 may be applied here if there are several advertisements possible from the highest bidder.

Thus, one advertisement is being selected by use of filtering methods described above and FIG. 2c continues after the user has received one advertisement 222, 224. Along with the video content of an advertisement it is defined an interaction component in all advertisements displayed to the viewer. The purpose of this interactive component is to provide a way for the IMS IPTV provider to report to the Ad Providers 146 that a viewer has shown interest in an Ad. Another purpose is to keep information on the popularity of different Ads. In this FIG. 2c it is disclosed that if the user clicks an offer displayed in the Ad (step 226) then in step 228 the User Preference database DB 109 is being updated with the information that this Ad is interacted by the user. Optionally in step 228 the Service Provider gets paid by the Ad Provider having an Ad which has been chosen by the user when this information is updated in the User Preference Database.

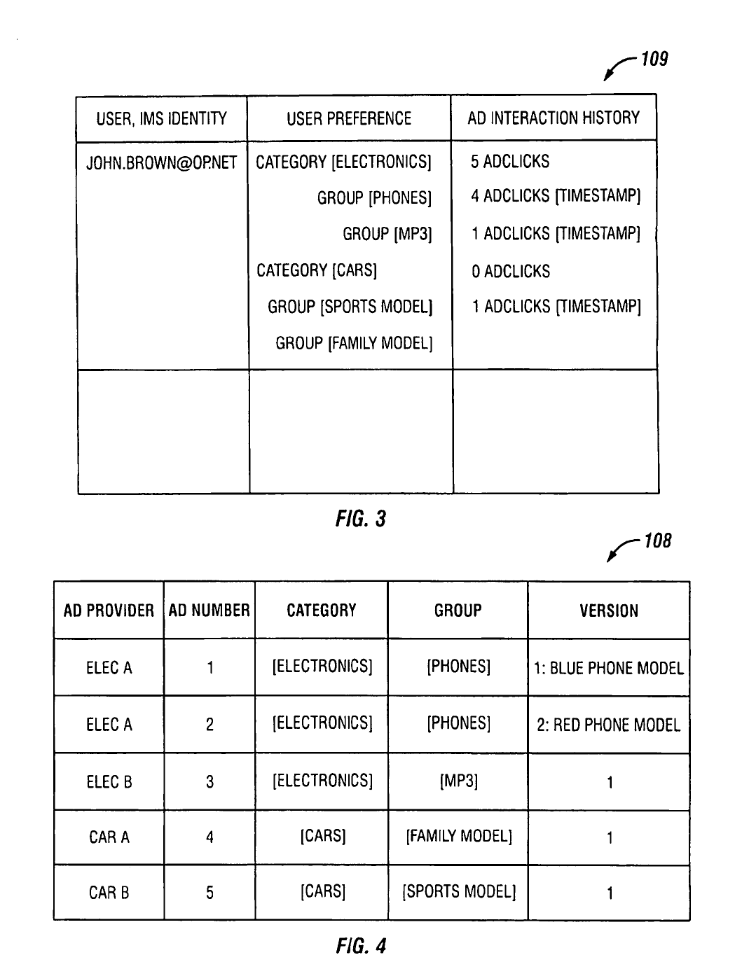

FIG. 3 shows an embodiment of the User Preference Database DB 109 in the IPTV Ad Provider 110 in FIG. 1. The first column keeps information about users. In this example the IMS Identity (John.Brown@op.net) is used. In the next column the user preferences are listed in Categories and Groups. The STB IPTV Client 103 is able to provide a user interface for interactivity such as the display of thumbnails each representing an Advertisement. Each click on a thumbnail (the Ad has been viewed by the user) will result in a relevant SIP message send to the Ad AS 105 (in FIG. 1) triggering an update of the viewer preference information and invocation of a corresponding business transaction, such as payment to the Service Provider from the Ad Provider. The last and third column keeps the Ad interaction history. In this example there is one category [electronics] with 2 different groups [phones] and [mp3]. In another Category [cars] there are 2 groups [sports model] and [family model]. The Ad interaction history shows the number of clicks for each category and group as well as a timestamp for each click. Instead of using categories or groups it the preference information could be based on tags where users just mention popular key words or similar. The category plus group combination is just one example of how to populate a database.

FIG. 4 shows an example of an Advertising Providers DB 108 in FIG. 1. This database keeps information about all available advertisements from different Ad Providers. There are 5 columns for Ad Provider, Ad number, Category, Group and Version. Ad Providers in this example are ELEC A, ELEC B within the category [Electronics]. In the matching procedure (step 204 in FIG. 2a) the user preference column in FIG. 3 is compared with the Category and the Group column in FIG. 4 and the result of this comparison is one or more Ad. Numbers. The algorithm for how the comparison is done is not part of this invention and not further described in this patent application. However, the result may be one or more ads from one or more Ad Providers.

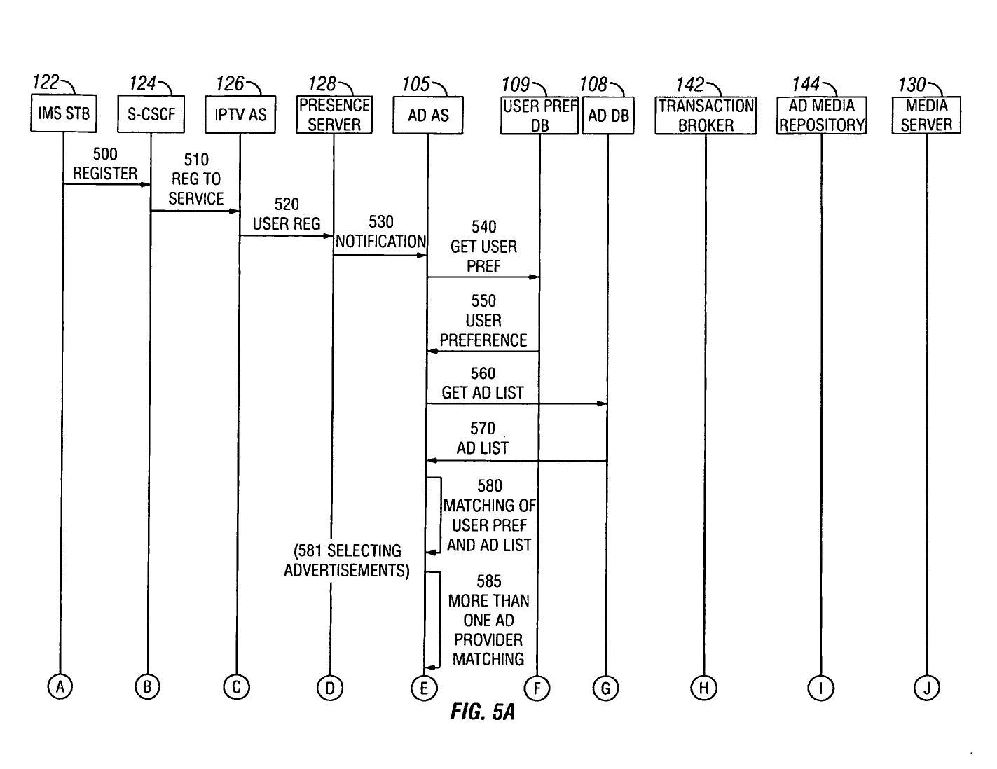

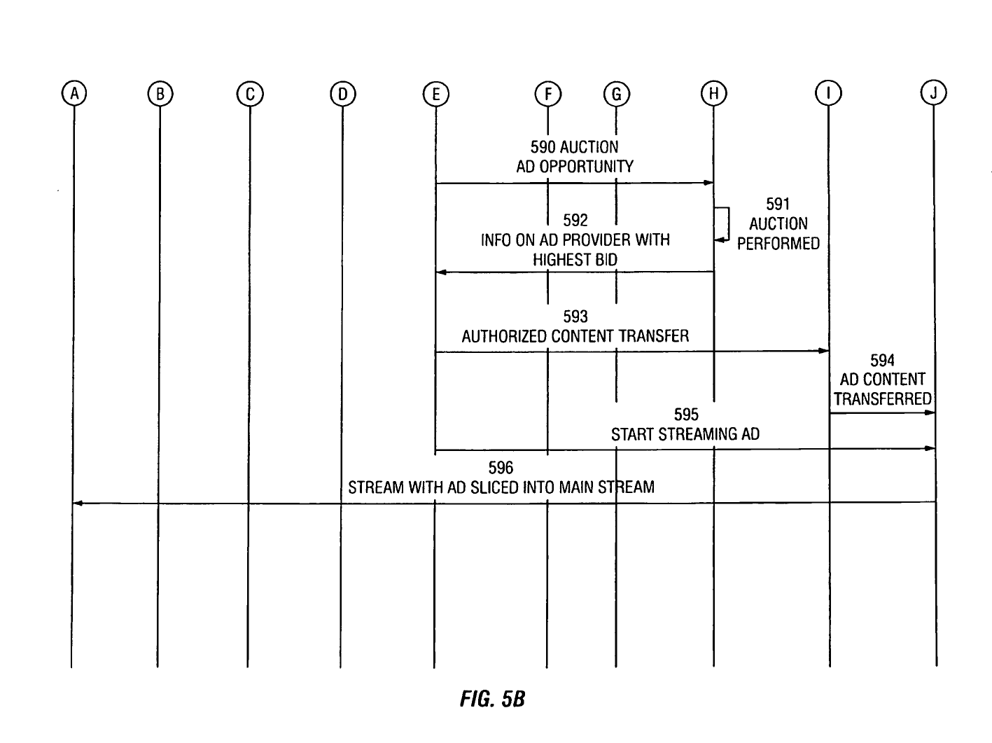

In order to get a deeper understanding of the invention a sequence diagram in FIG. 5 shows the interaction among the different nodes in the system according to FIG. 1. The STB 102 residing in a home Local Area Network LAN displays the video stream which includes the TV content and the Ad content to the end viewer 101. The prerequisite in this invention is that the STB has an IMS client and the viewer is able to access the IPTV service by logging in with an IMS Public Identity IMPU to the IMS system. In this invention it is implemented in the way that the IPTV client 103 has an interface to an IMS client 104. If the scenario is a non-IMS scenario the IPTV client can use another communication entity to be able to reach the IPTV AS 126. The IMS STB 102 with the IMS client registers to the S-CSCF 124 with a SIP message 500. The S-CSCF 124 authenticates the user and sends a SIP message 510 to the IPTV AS 126 to register to the TV service. The IPTV AS sends a message 520 about user registration to the Presence server 128 which in turn notifies 530 the Advertisement Application Server 105 that the user has registered for IPTV service in the IMS core system. Thus, the Ad AS 105 now has detected that a user has logged in for TV service and is present at the IPTV client and the TV viewer will get personalized advertisements according to the invention. In order to process what advertisement to send to the user the Ad AS sends a message 540 to the User Preference DB 109 to get the user preferences which are sent to the Ad AS in message 550. In next step the list of advertisements from different Ad providers are received 570 from the Ad Providers DB 108. According to the description in FIG. 4 the list discloses information on advertisements from different Ad Providers. A matching procedure 580 is done in the Ad AS and under this procedure the user preference list is compared with the list of advertisements. From the matching procedure one or more advertisements are being selected 581 when there is a match between the advertisements and the preferences.

Said selecting step includes the use of an appropriate criteria for making the selection. One useful criteria is the best match criteria, which is obvious and can be from FIGS. 3 and 4 for instance the group phones which will thus generate a match for Ad number 1 and 2. If there are many advertisements possible when using the best match criteria it can be combined with a criteria for the most popular Ad in order to reduce the number of possible Ads.

If it is determined in the selection procedure that more than one Ad Provider has a matching advertisement then the Ad AS 105 sends 590 an auction invitation, similar to an auction Ad opportunity, to the Transaction Broker 142. The Transaction Broker 142 performs 591 the auction among the Ad Providers. This procedure is not described in detail. The result of the auction is the highest bidder and the information on the highest bidder is sent 592 from the Transaction Broker 142 to the Ad AS 105 where it is received. Now the Ad AS is informed about which Ad Provider has the highest bid and thus which advertisement is to be sent to the viewer. Optionally, as earlier mentioned, a list of advertisements can be sent to the viewer who can select Ad by doing a click in the list.

According to the invention described above the user when watching TV will receive personal advertisements that fits well with the interest of the user which makes the advertisements interesting to the user. The system manages and delivers personalized advertisement which both Ad. Providers and Service Providers benefit from. A further advantage of the system is the option of including payment from the Ad Providers to the Service Provider upon a user viewing the advertisements or the Service Provider updating the User Preference Database.

In step 593 a message “Authorized Content Transfer” is sent to the Ad Media Repository 144. This message contains information about which ad from the Ad DB to be sent to the viewer. The Ad media Repository then in message 594 sends the actual ad to the media server 130. Upon a signal “Start Streaming Ad” 595 from the Ad AS 105 to the Media Server 130 the Media server includes the Ad in the streaming of the TV content. This is indicated

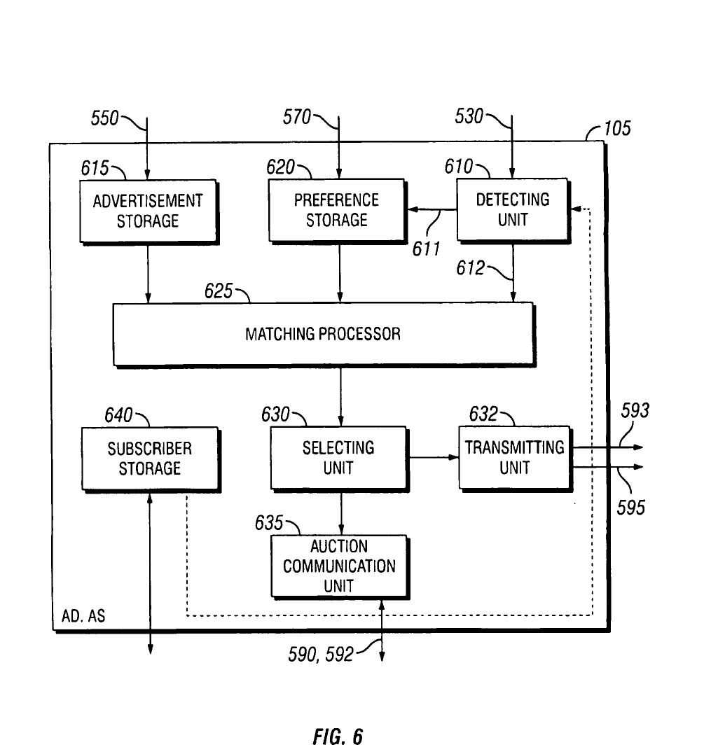

A block diagram of the Advertising Application Server Ad AS 105 is shown in FIG. 6. The block diagram is a functional view of the Ad AS 105. There is a Detecting Unit 610 for detection of user presence information upon notification from the Presence Server 128 in FIG. 1. There is also an Advertisement Storage 615 for storing of advertisements from different Ad Providers. Instead of a storage 615 the implementation may be just an Input 615 where the information on advertisements is entered but not stored. The Advertisement Storage or Input 615 is connected with the Ad Providers DB 108 in the IPTV Ad provider 110 (see FIG. 1) A Preference Storage 620 is used to store preferences for a user who is detected by the detection unit to be present as a TV viewer, ie the user is online. The Preference Storage, in an alternative embodiment, may be an Input and the information may not be stored but entered in order to be used. The Detecting Unit 610 is connected 611 with the Preference Storage 620 to send information to download or fetch preferences for a detected user. The Advertisement Storage 615 and the Preference Storage 620 according to the storage example are portions of RAM (Random Access Memory) of the Ad AS 105 and they are used to initially place all entries from the databases 108 and 109 (in FIG. 1) for fast access to the appropriate data. A Matching Processor 625 is connected to the Advertisement Storage 620. The Preference Storage 615 and to the Detecting Unit 610. The Matching Processor 625 processes the information in the preference storage 620 and the information in the Advertisement storage 615 upon a start order 612 from the Detecting Unit 610 which means that an identified user is present at the STB. How the processing is done is earlier described. The result from the Matching Processor 625 is sent to a connected Selecting Unit 630 which has the tasks of selecting advertisement according to an appropriate criteria and a further task of determining if there are more than one Ad Provider with Advertisements as a result from the Matching processor. Connected with the Selecting Unit 630 is a Transmitting Unit 632 for initiating the delivery of the one or more advertisements to the IPTV client. The Transmitting Unit 632 is connected with the earlier presented Ad Media Repository 144 and with the also earlier mentioned Media Server 130 for sending a start stream message.

The Ad. AS 105 also includes an Auction Communication Unit 635 connected with the Transaction Broker 142 for communication in cases when Advertisements from more than one Advertiser has been selected. The Auction Communication Unit 635 is also connected with the Selecting Unit 630 to receive information on when to contact the Transaction Broker 142. The Auction Communication Unit (635) transmits an auction Ad opportunity to the Transaction Broker (142) and receives back information on Ad provider with highest bid.

There is also a Subscriber Storage 640 for keeping information about subscribers of the IPTV personalized advertisement service. Upon reception of an IPTV client ID as a subscriber to the service there is a notification from the Subscriber Storage 640 to the Detecting Unit 610 to subscribe to presence status from the Presence Server 128. The Subscriber Storage 640 is connected to the Detecting Unit 610 as shown with dotted lines in FIG. 6.

The invention is described as being implemented in an IMS (IP Multimedia Subsystem) with SIP (Session Initiation Protocol) signaling but the invention is not limited to such technical systems. Also other systems and signals can be used as long as the system is able to keep login information and is aware of when the user is watching TV on a client or terminal applicable in the system. For instance the terminal or client may be a STB Set Top Box according to the example or a PC terminal or a mobile terminal.

1. A method of managing personalized advertisement in a TV system including a TV client, a User Preference Database, an Ad Providers Database and an Advertising Application Server, said method being performed in the Advertising Application Server and is comprising the steps of:
detecting user presence at the TV client;
receiving, from said User Preference Database, preferences of said detected user;
receiving, from the Ad Providers Database, information on advertisements from different Ad Providers;
matching said received user preferences with received information on advertisements and
selecting one or more advertisements when there is a match between the advertisements and the preferences.

2. The method according to claim 1, further comprising the steps of initiating transmission of selected advertisement to the TV client.

3. The method according to claim 1, wherein said detecting step comprises notification about user login to the system.

4. The method according to claim 3, wherein said notification is received from a Presence Server.

5. The method according to claim 1, wherein said selecting step comprises best match criteria.

6. The method according to claim 1, wherein said selecting step comprises best match criteria in combination with most popular Ad criteria.

7. The method according to claim 1, wherein said method further comprising the following steps, performed in the Advertising Application Server:
detecting/determining that Advertisements from more than one Ad Provider has been selected:
sending auction invitation to a Transaction Broker Node;
receiving information on the Ad Provider with highest bid and
initiating transmission of advertisement from highest bidder to user.

8. The method according to claim 7, wherein said initiation transmission step comprises Authorized Content Transfer information sent to an Ad Media Repository and Start Streaming Ad information sent to a Media Server.

9. An Advertising Application Server in a TV system for managing personalized advertisement to be delivered to a TV client in the system said Advertising Application Server comprising:
a Detecting Unit for detection of user presence at the TV client:
an input for preferences from the detected user:
an input for information on advertisements from different Ad providers:
a Matching Processor for matching user preferences with information on advertisements and
a Selecting Unit for selecting advertisements and for determining if Advertisements from one Ad Providers has been selected:
a Transmitting Unit for initiating the delivery of the one or more advertisements to the client.

10. An Advertising Application Server according to claim 9 wherein the Detecting Unit is connected with the Presence Server and has a subscription for presence status of subscribers of the Personalized Advertising TV service.

11. An Advertising Application Server according to claim 9, further comprising a Subscriber Storage connected to the Detecting Unit for informing the Detecting Unit about subscribers of the Personalized Advertising TV service.

12. An Advertising Application Server according to claim 9 wherein the Selecting Unit determines if more than one Ad Provider has been selected.

13. An Advertising Application Server according to claim 12, further comprising An Auction Communication Unit being connected to the Selecting Unit and the Transaction Broker for transmitting auction Ad opportunity to the Transaction Broker and for receiving information on Ad provider with highest bid.

14. A TV system for delivering of personalized advertisements to a TV client the system including:
a Presence Server for determining user presence at the TV client:
a User Preference Database for storing of user preferences;
an Advertisement Application Server for matching of user preferences in said database with available advertisements upon user presence detected and for initiating the delivery of matched advertisements to the TV client.

15. An TV system according to claim 14 further including:
an Advertisement Providers Database having available Advertisements stored from different Ad Providers for transmitting said available Advertisements to the Advertisement Application Server.

16. An TV system according to claim 14 further including:
a Transaction Broker connected with the Advertising Application Server for performing an auction upon an auction Ad opportunity received from the Advertisement Application Server and for transmitting information on the Ad Provider with highest bid back to the Advertising Application Server.

17. A method in an TV system for delivering of personalized advertisements to an TV client where user preferences are stored in a User Preference Database and available advertisements area stored in an Ad Providers Database the method including the following steps:
monitoring user presence at the TV client and upon detection of user presence:
matching of user preferences with available advertisements upon user presence and
selecting one or more Advertisement to be delivered to the TV client.

18. A method in an TV system according to claim 17 further including the following steps when more than one Ad Provider is having advertisements that have been selected in the selecting step:
initiating an Auction Ad opportunity with a Transaction Broker:
performing of the auction and determining the highest bidder by the Transaction Broker and
sending matched advertisement from highest bidder to the TV client.

19. A method in an TV system according to claim 17 further including the following steps when one Ad Provider is having advertisements that have been selected in the selecting step:
showing selected advertisement to the TV client.

20. A method in an TV system according to claim 19 further including the step of payment to the Service Provider.

21. A method in an TV system according to claim 17 further including the following steps when one Ad Provider is having advertisements that have been selected in the selecting step:
showing a list of advertisements to the TV client;
if user chooses any advertisement in the list then the selected advertisement is being shown to the user.

22. A method in an TV system according to claim 21 further including the steps of payment to the Service Provider.

23. A method in an TV system according to claim 18 or 19 further including the following steps:
interaction by the TV client in an advertisement that has been shown to the user and
updating of User Preference Database with interaction information.

24. A method in an TV system according to claim 23 further including the step of payment to the Service Provider.
